(19) United States
(12) Patent Application Publication
(10) Pub. No.: US 2012/0006167 A1
(43) Pub. Date: Jan. 12, 2012

(54) RIP FENCE DEVICE FOR TABLE SAW

(75) Inventor: Chia-Sheng LIU, Taichung County (TW)

(73) Assignee: DURQ MACHINERY CORP., Taichung (TW)

(21) Appl. No.: 12/876,513

(22) Filed: Sep. 7, 2010

(30) Foreign Application Priority Data
Jul. 7, 2010 (TW) 99122345

(51) Int. Cl. B27B 27/08

(52) U.S. Cl. 83/444

(57) ABSTRACT

A rip fence device for a table saw includes two parallel and spacedly arranged rails, two rotating plates pivotally and respectively connected with the rails, and a fence plate pivotally connected between the rotating plates and having a first stop wall and a second stop wall, which are vertical to each other. As a result, when the rip fence device is pulled outwards away from a lateral side of a worktable of the table saw, the lateral edge of a to-be-cut workpiece can be stopped at the second stop wall of the fence plate, and the bottom of the workpiece can be supported by the first stop wall of the fence plate, thereby allowing the workpiece to be firmly supported in the cutting process.

### BACKGROUND OF THE INVENTION

1. Field of the Invention

The present invention relates generally to a table saw, and more specifically to a rip fence device for a table saw, which can stably support the workpiece under cutting.

2. Description of the Related Art

A conventional table saw is generally equipped with a rip fence for stopping at a lateral side of a workpiece under cutting so as to determine and restrict the cutting width of the workpiece. By means of the cooperation of rails with channels, the rip fence is slidably moveable relative to the worktable, and furthermore the rip fence can be locked on a lateral side of the worktable or on the rail by using a locking device.

If a to-be-cut workpiece has a width greater than that of a support zone of the worktable, the rip fence will need to be pulled outwardly away from the worktable to a proper distance for enabling the rip fence to be stoppable at the lateral side of the workpiece so as to determine the cutting width of the workpiece. Under this circumstance, a part of the workpiece will be suspended outside the worktable such that the workpiece may not be firmly supported in the cutting process. Even though a support device has been provided for the rip fence to offer a better support to a large-sized workpiece during cutting, it has a drawback of complicated design.

### SUMMARY OF THE INVENTION

It is one objective of the present invention to provide a rip fence device for a table saw, which has a simple structure and can firmly support a large-sized workpiece.

It is another objective of the present invention to provide a rip fence device for a table saw, which can reduce an error of the cutting length of a workpiece.

To achieve these objectives of the present invention, the rip fence device provided by the present invention comprises two rails arranged in a parallel and spaced manner, two rotating plates each having a stop edge and each pivotally connected with one of the rails in a way that the rotating plates are pivotable between a vertical position where the stop edges of the rotating plates are vertical to longitudinal axes of the rails, and a horizontal position where the stop edges of the rotating plates are parallel to the longitudinal axes of the rails, and a fence plate having a first stop wall and a second stop wall, which are vertical to each other. The fence plate is pivotally connected between the rotating plates in a way that the fence plate is pivotable between a first position where the first stop wall of the fence plate is substantially flushed with the stop edges of the rotating plates, and the second stop wall of the fence plate is vertical to the stop edges of the rotating plates, and a second position where the first stop wall of the fence plate is vertical to the stop edges of the rotating plates, and the second stop wall of the fence plate is substantially flushed with the stop edges of the rotating plates.

When the rip fence device is pulled outwards away from a lateral side of a worktable of the table saw, the lateral edge of a to-be-cut workpiece can be stopped against the second stop wall of the fence plate located at the second position, and the bottom of the workpiece can be supported by the first stop wall of the fence plate located at the second position, such that the workpiece can be firmly supported in the cutting process. In addition, when the rotating plates are rested at the horizontal position, the rip fence device of the present invention can be served as an auxiliary support device to fully and firmly support a large-sized workpiece for cutting.

Preferably, the rip fence device may comprises a retaining unit including a pivot riveted against a retaining plate mounted with one of the rails and one of the rotating plates, a guide rod connected with one of the rotating plates and inserted into a curved guide slot of the retaining plate, and a retaining member connected with the guide rod to lock the guide rod in the curved guide slot.

Preferably, the rip fence device may comprises a locating unit including a mount fastened to the second stop wall of the fence plate, and a locating rod axially and movably inserted into the mount and engagable with two ends of a curved locating slot of the rotating plate for retaining the fence plate in the first position and the second position.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of a table saw in which a rip fence device according to a preferred embodiment of the present invention in installed;

FIG. 2 is another perspective view of the table saw, showing the rip fence device is drawn away from a lateral side of a worktable of the table saw;

FIG. 3 is a perspective view of a rip fence device according to the preferred embodiment of the present invention;

FIG. 4 is an explode view of parts of the rip fence device according to the preferred embodiment of the present invention;

FIG. 5 is a lateral view of the rip fence device according to the preferred embodiment of the present invention, showing the rotating plate is located at the vertical position, and the fence plate is located at the first position;

FIG. 6 is a sectional view of parts of the rip fence device according to the preferred embodiment of the present invention, showing the large diameter portion of the locating rod is engaged with the first large diameter end of the curved locating slot;

FIG. 7 is similar to FIG. 5, but showing the rip fence device is rotated from the first position to the second position;

FIG. 8 is similar to FIG. 6, but showing the small diameter portion of the locating rod is located at the small section of the curved locating slot when the locating rod is pressed;

FIG. 9 is similar to FIG. 7, but showing the rip fence device is located at the second position; and

FIG. 10 is a lateral view of the rip fence device according to the preferred embodiment of the present invention, showing the rotating plate is located at the horizontal position, and the fence plate is located at the first position.

### DETAILED DESCRIPTION OF THE INVENTION

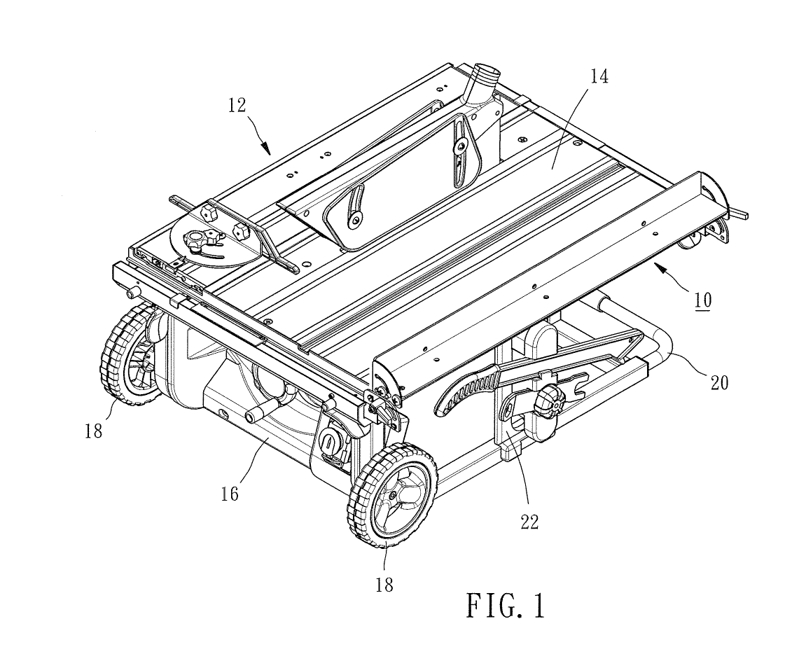

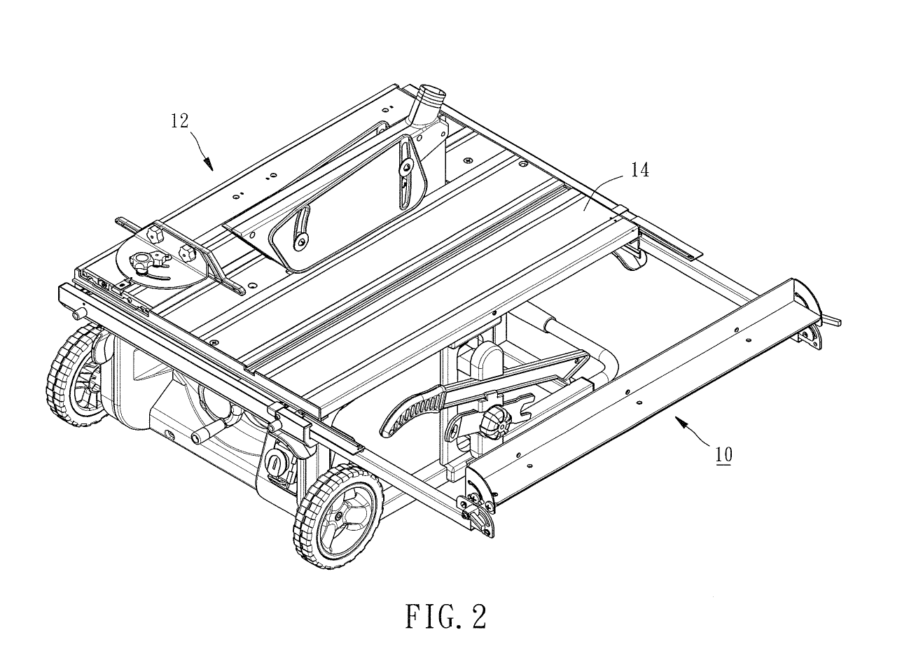

As shown in FIGS. 1-2, a rip fence device 10 in accordance with a preferred embodiment of the present invention is slidably connected with a worktable 14 of a table saw 12. In this embodiment, the table saw 12 includes a base 16, two wheels 18 rotatably and respectively mounted to two corners of the front side of the base 16, a retractable handlebar 20 provided at the rear side of the base 16 for being held by a user to conveniently move the table saw 12, and a rack 22 at a lateral side of the base 16 for accommodation of processing tools, accessories or the like. It will be appreciated that the rip fence device 10 of the present invention can be used in cooperation with any kind of sawing machine, not limited to the table saw 12 as shown in FIGS. 1-2.

As shown in FIG. 1, the rip fence device 10 can be abutted with the lateral side of the worktable 14. If a to-be-cut workpiece (not shown) has a width exceeding the width of the effective support zone of the worktable 14, the rip fence device 10 can be slidably pulled apart from the lateral side of the worktable 14 to a desired position, as shown in FIG. 2, such that the lateral side of the workpiece can be stopped at the rip fence device 10 so as to be held in position for cutting.

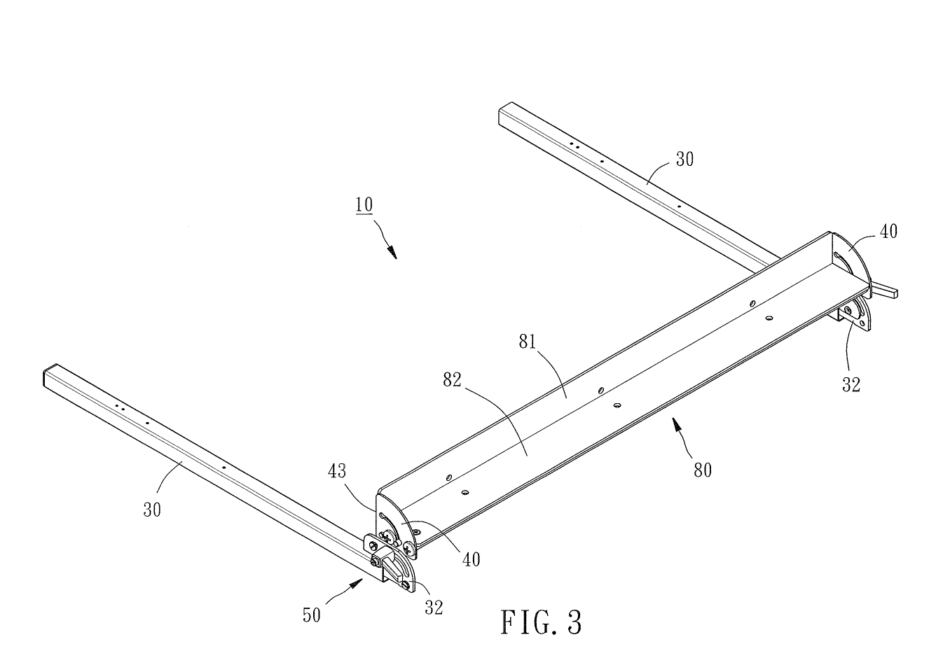

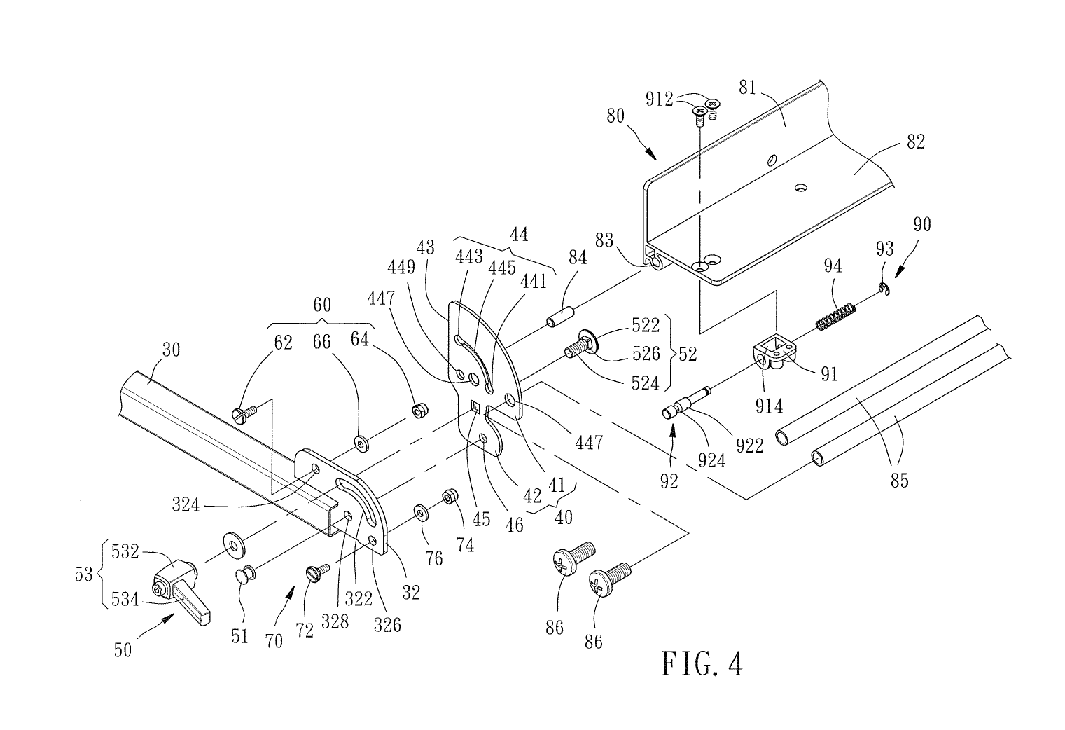

As shown in FIGS. 3-4, the rip fence device 10 provided by a preferred embodiment of the present invention comprises two rails 30, two rotating plates 40, two retaining units 50, two first adjustment members 60, two second adjustment members 70, a fence plate 80, two shafts 84, two support rods 85, and two locating units 90. Since the structures of the rails 30, the rotating plates 40, the retaining units 50, the first adjustment members 60, the second adjustment members 70, the shafts 84, and the locating units 90 are the same and/or symmetric, only one set of the rail 30, the rotating plate 40, the retaining unit 50, the first adjustment member 60, the second adjustment member 70, the shaft 84, and the locating unit 90 will be detailedly described hereunder for concise illustration of the present invention. By reference to the following detailed description, a person having ordinary skill in the related art can fully understand the whole features, structures and operation of the rip fence device 10 of the present invention.

The rail 30 is a rectangular tube, having one end slidably inserted into a side of the worktable 14, and the other end mounted with a retaining plate 32. The retaining plate 32 is provided with a curved guide slot 322, a first through hole 324 at the left side of the curved guide slot 322, a second through hole 326 at the bottom right of the curved guide slot 322, and a first pivot hole 328 at the bottom of the curved guide slot 322.

The rotating plate 40 includes a sectorial stop portion 41 and a pivot portion 42 at the bottom of the stop portion 41. The stop portion 41 has a curved edge, two straight edges, one of which defines a stop edge 43, a curved locating slot 44 at a middle thereof with a first large diameter end 441, a second large diameter end 443, and a small diameter section 445 between the first large diameter end 441 and the second large diameter end 443, two retaining holes 447 at two opposite sides of the first large diameter end 441, and a shaft hole 449 at the left side of one of the retaining holes 447. The pivot portion 42 extends integrally and downwardly from the other one of the straight edges of the stop portion 41, and has a rectangular through hole 45 corresponding in location to the curved guide slot 322 of the rail 30, and a second pivot hole 46 corresponding in location to the first pivot hole 328 of the rail 30.

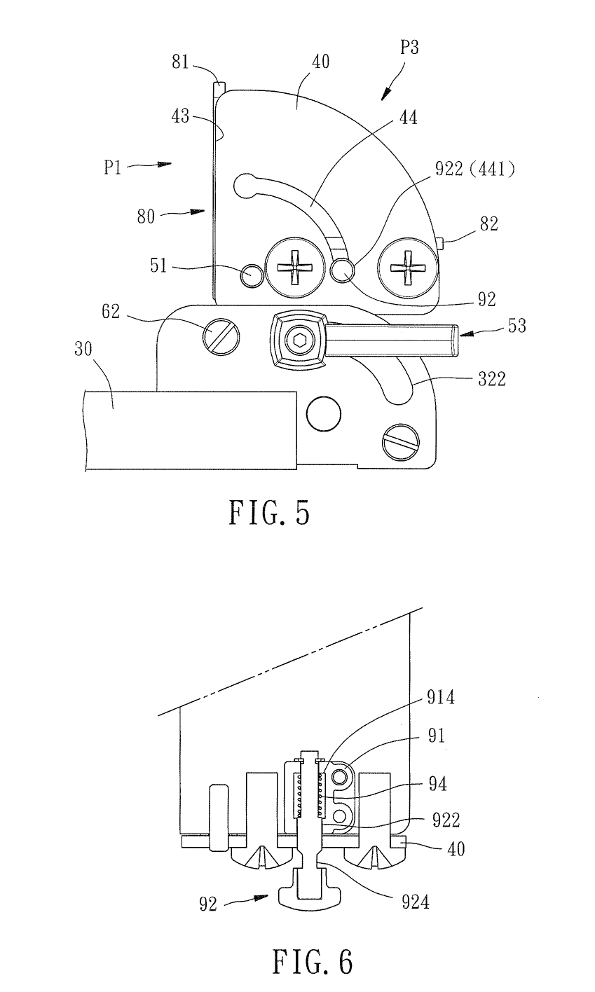

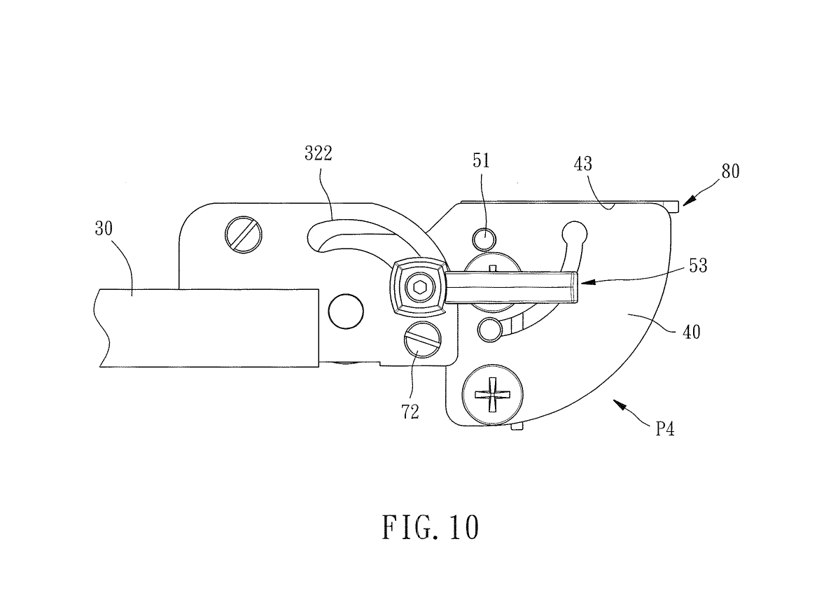

The retaining unit 50 includes a pivot 51 inserted into the first pivot hole 328 of the retaining plate 32 and the second pivot hole 46 of the rotating plate 40, and having two ends riveted against the retaining plate 32 and the rotating plate 40. The retaining unit 50 further includes a guide rod 52 having a head 522 abutted against a side of the stop portion 41 of the rotating plate 40, a threaded body 524 passing through the rectangular through hole 45 of the rotating plate 40 and the curved guide slot 322 of the retaining plate 32, and a rectangular neck 526 between the head 522 and the threaded body 524, which is inserted into the rectangular through hole 45 of the rotating plate 40, and a retaining member 53 having a nut 532 engaged with the threaded body 524 of the guide rod 52, and a handle 534 extending outwardly from the nut 532. By this way, the rotating plate 40 can be turned about the pivot 51 and along the path of the curved guide slot 322 between a vertical position P3, as shown in FIG. 5, and a horizontal position P4, as shown in FIG. 10, relative to the rail 30. When the rotating plate 40 is located at the vertical position P3, the stop edge 43 of the rotating plate 40 is vertical to a longitudinal axis of the rail 30, and when the rotating plate 40 is located at a horizontal position P4, the stop edge 43 of the rotating plate 40 is parallel to the longitudinal axis of the rail 30. Furthermore, when the rotating plate 40 is stayed at the vertical position P3 or the horizontal position P4, the retaining member 53 can be tightened through the handle 534 to drive the guide rod 52 through the nut 53 to lock the guide rod 52 in the curved guide slot 322. That is, the rotating plate 40 is locked to firmly stop against the retaining plate 32 of the rail 30.

The first adjustment member 60 includes a first eccentric screw 62 inserted into the retaining plate 40 through the first through hole 324, a first nut 64 threaded with the first eccentric screw 62, and a first washer 66 sleeved on the first eccentric screw 62 and having two sides respectively stoppable against the retaining plate 40 and the first nut 64, as shown in FIG. 4. If the stop edge 43 of the rotating plate 40 is not vertical to the longitudinal axis of the rail 30 when the rotating plate 40 is located at the vertical position P3, the first eccentric screw 62 can be turned by a user to force the first washer 66 to stop against the rotating plate 40 for adjusting an angle of the rotating plate 40 at the vertical position P3.

The second adjustment member 70 includes a second eccentric screw 72 inserted into the retaining plate 40 through the second through hole 326, a second nut 74 threaded with the second eccentric screw 72, and a second washer 76 sleeved on the second eccentric screw 72 and having two sides respectively stoppable against the retaining plate 40 and the second nut 74, as shown in FIGS. 4. If the stop edge 43 of the rotating plate 40 is not parallel to the longitudinal axis of the rail 30 when the rotating plate 40 is located at the horizontal position P4, the second eccentric screw 72 can be turned by a user to force the second washer 76 to stop against the rotating plate 40 for adjusting an angle of the rotating plate 40 at the horizontal position P4.

The fence plate 80 has a first stop wall 81 and a second stop wall 82, which are vertical to each other, and has an elongated groove 83 at the bottom of a joint between the first stop wall 81 and the second stop wall 82, which extends along a longitudinal axis of the fence plate 80 and corresponds in location to the shaft hole 449 of the rotating plate 40.

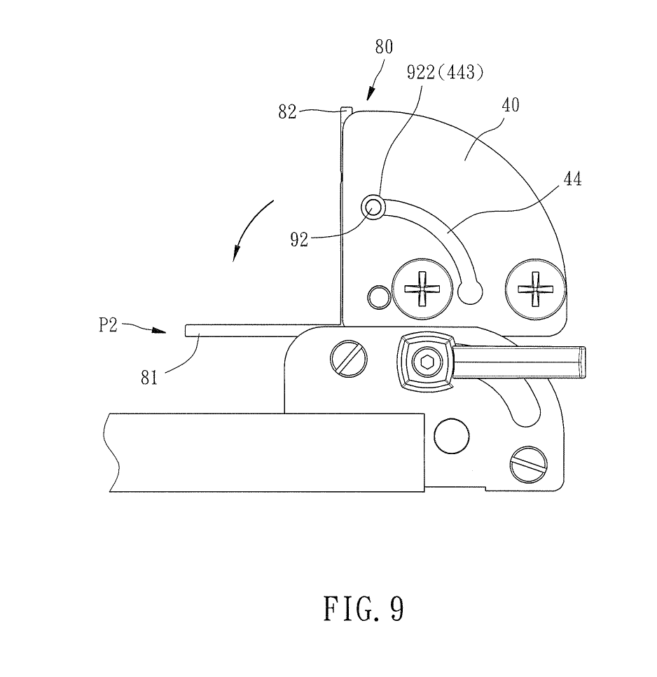

The shaft 84 is tightly inserted into the elongated groove 83 of the fence plate 80, and pivotally inserted into the shaft hole 449 of the rotating plate 40. By this way, the fence plate 80 is turnable about the shaft 84 between a first position P1, as shown in FIG. 5, and a second position P2, as shown in. FIG. 9, relative to the rotating plate 40. When the fence plate 80 is located at the first position P1, the first stop wall 81 of the fence plate 80 is substantially flushed with the stop edge 43 of the rotating plate 40, and the second stop wall 82 of the fence plate 80 is vertical to the stop edge 43 of the rotating plate 40. When the fence plate 80 is located at the second position P2, the first stop wall 81 of the fence plate 80 is vertical to the stop edge 43 of the rotating plate 40, and the second stop wall 82 of the fence plate 80 is substantially flushed with the stop edge 43 of the rotating plate 40.

The support rods 85 are fastened between the two rotating plates 40 through screws 86 respectively inserted into one of the retaining holes 447 of the rotating plate 40, and adjoined with the bottom of the second stop wall 82 of the fence plate 80 for preventing an excessive rotation of the fence plate 80 at the first position P1.

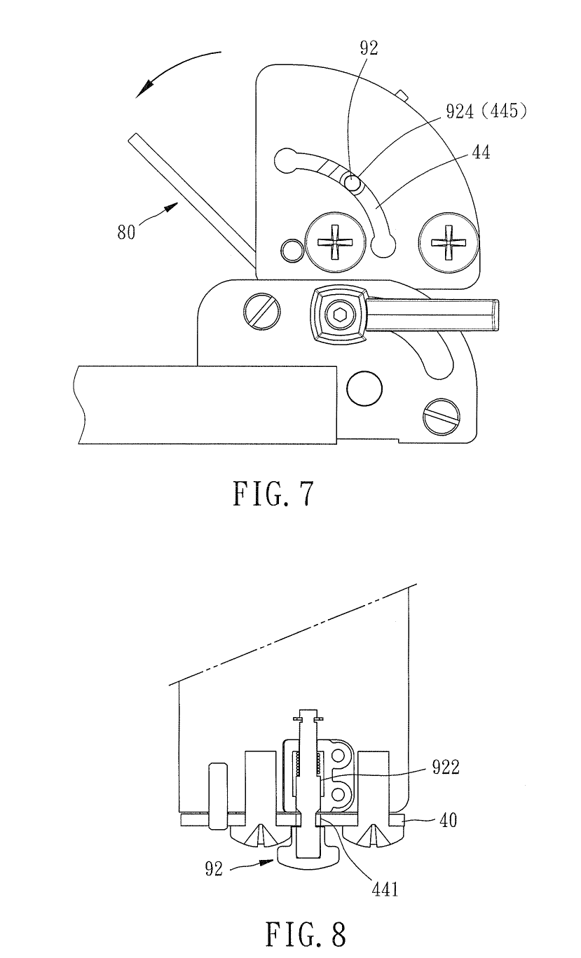

The locating unit 90 includes a mount 91 fastened to the bottom of the second stop wall 82 of the fence plate 80 through two screws 912 and located between the support rods 85 and provided with a chamber 914, a locating rod 92 axially and movably inserted into the mount 91 and having a large diameter portion 922 and a small diameter portion 924, as shown in FIGS. 4 and 6, a fastener 93 engaged with the distal end of the locating rod 92 to prevent separation of the locating rod 92 from the mount 91, and a spring member 94 sleeved on the locating rod 92 and having two ends respectively stopped against an end wall of the chamber 914 of the mount 91 and the large diameter portion 922 of the locating rod 92, as shown in FIG. 6. By this way, when the large diameter portion 922 of the locating rod 92 is engaged with the first large diameter end 441 of the curved locating slot 44, as shown in FIG. 5, the fence plate 80 is retained in the first position P1, and when the large diameter portion 922 of the locating rod 92 is engaged with the second large diameter end 443 of the curved locating slot 44, the fence plate 80 is retained in the second position P2, as shown in FIG. 9, and when the small diameter portion 924 of the locating rod 92 is slidably moved in the small diameter section 445 of the curved locating slot 44, the fence plate 80 is pivotable between the first position P1 and the second position P2, as shown in FIG. 7. In addition, by means of the elastic force provided by the spring member 94, the large diameter portion 922 of the locating rod 92 can be forced to be selectively engaged with one of the first and second large diameter ends 441 and 443 of the curved locating slot 44.

The structure of the rip fence device 10 is described as above, and the operation of the rip fence device 10 of the present invention is outlined hereinafter.

As shown in FIG. 5, when the fence plate 80 is located at the first position P1, the lateral side of a to-be-cut workpiece can be directly stopped at the first stop wall 81 of the fence plate 80 so as to determine the cutting width; and further, since the first stop wall 81 of the fence plate 80 is substantially flushed with the stop edges 43 of the rotating plates 40, an error of the cutting length of the to-be-cut workpiece can be effectively reduced.

If a large-sized workpiece needs to be cut, the rip fence device 10 of the present invention can be slidably and outwardly pulled away from the worktable 14 to a desired distance, as shown in FIG. 2, and then the user can press the locating rod 92 to allow the disengagement of the large diameter portion 922 of the locating rod 92 from the first large diameter end 441 of the curved locating slot 44 of the rotating plate 40, as shown in FIG. 8, and then the user can force the small diameter portion 924 of the locating rod 92 to slidably move along the small large section 445 of the curved locating slot 44 of the rotating plate 40 to the second large diameter end 443 of the curved locating slot 44 of the rotating plate 40. Thereafter, the user can release the force applying on the locating rod 92 to allow the engagement of the large diameter portion 922 of the locating rod 92 with the second large diameter end 443 of the curved locating slot 44 of the rotating plate 40, as shown in FIG. 9, for retaining the fence plate 80 in the second position P2. As a result, the lateral side of the large-sized workpiece can be directly stopped at the second stop wall 82 of the fence plate 80, and the bottom of the large-sized workpiece can be supported by the first stop wall 81 of the fence plate 80 for facilitating the cutting of the large-sized workpiece; moreover, since the second stop wall 82 of the fence plate 80 is substantially flushed with the stop edges 43 of the rotating plates 40, the large-sized workpiece can be cut in a desired length.

On the other hand, the rotating plates 40 can be set to the horizontal position P4 by means of using the retaining units 50, as shown in FIGS. 5 and 10, such that the fence plate 80 and the rotating plates 40 can fully and firmly support the large-sized workpiece in a cutting process.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A rip fence device for a table saw, comprising:
two rails arranged in a parallel and spaced manner;
two rotating plates each having a stop edge and pivotally connected with one of the rails in a way that the rotating plates are pivotable between a vertical position where the stop edges of the rotating plates are vertical to longitudinal axes of the rails, and a horizontal position where the stop edges of the rotating plates are parallel to the longitudinal axes of the rails; and
a fence plate having a first stop wall and a second stop wall, which are vertical to each other, the fence plate being pivotally connected between the rotating plates in a way that the fence plate is pivotable between a first position where the first stop wall of the fence plate is substantially flushed with the stop edges of the rotating plates and the second stop wall of the fence plate is vertical to the stop edges of the rotating plates, and a second position where the first stop wall of the fence plate is vertical to the stop edges of the rotating plates and the second stop wall of the fence plate is substantially flushed with the stop edges of the rotating plates.

2. The rip fence device as claimed in claim 1, further comprising two shafts, each of which is tightly inserted into one of two ends of an elongated groove of the fence plate extending along a longitudinal axis of the fence plate, and pivotally inserted into a shaft hole of one of the rotating plates.

3. The rip fence device as claimed in claim 1, further comprising a retaining unit including a pivot riveted against a retaining plate mounted with one of the rails and one of the rotating plates, a guide rod connected with one of the rotating plates and inserted into a curved guide slot of the retaining plate, and a retaining member connected with the guide rod to lock the guide rod in the curved guide slot.

4. The rip fence device as claimed in claim 3, wherein the rotating plate has a rectangular through hole, and the guide rod has a head abutted against the rotating plate, a threaded body passing through the curved guide slot of the retaining plate and threaded with the retaining member, and a rectangular neck between the head and the threaded body, which is inserted into the rectangular through hole of the rotating plate.

5. The rip fence device as claimed in claim 3, further comprising a first adjustment member having a first eccentric screw inserted through the retaining plate, a first nut threaded with the first eccentric screw, and a first washer sleeved on the first eccentric screw and located between the retaining plate and the first nut and stoppable against the rotating plate when the rotating plate is located at the vertical position for adjusting an angle of the rotating plate at the vertical position, and a second adjustment member having a second eccentric screw inserted through the retaining plate, a second nut threaded with the second eccentric screw, and a second washer sleeved on the second eccentric screw and located between the retaining plate and the second nut and stoppable against the rotating plate when the rotating plate is located at the horizontal position for adjusting an angle of the rotating plate at the horizontal position.

6. The rip fence device as claimed in claim 1, further comprising a locating unit including a mount fastened to the second stop wall of the fence plate, and a locating rod axially and movably inserted into the mount and engagable with two ends of a curved locating slot of the rotating plate for retaining the fence plate in the first position and the second position.

7. The rip fence device as claimed in claim 6, wherein the curved locating slot of the rotating plate has a first large diameter end, a second large diameter end and a small diameter section between the first large diameter end and the second large diameter end, and the locating rod has a large diameter portion engaged with the first diameter end of the curved locating slot when the fence plate is located at the first position and engaged with the second diameter end of the curved locating slot when the fence plate is located at the second position, and a small diameter portion slidably moved in the small diameter section of the curved locating slot when the fence plate is pivotally moved between the first position and the second position.

8. The rip fence device as claimed in claim 7, wherein the locating unit includes a spring member sleeved on the locating rod and having two ends respectively stopped against the mount and the large diameter portion of the locating rod for providing an elastic force to maintain engagement of the large diameter portion of the locating rod with one of the first large diameter end and the second large diameter end of the curved locating slot.

9. The rip fence device as claimed in claim 1, further a support rod connected between the rotating plates and adjoined with a bottom of the second stop wall of the fence plate.
